(19) United States
(12) Patent Application Publication
(10) Pub. No.: US 2008/0288572 A1
(43) Pub. Date: Nov. 20, 2008

(54) SCALABLE PRESENCE SERVER ARCHITECTURE

(76) Inventors: James Patrick Galvin, JR., Oak Ridge, NC (US); Avshalom Houri, Netivot (IL); Yaki Kupherstein, Kibbutz Revadim (IL); Amir Perlman, Yahud (IL); Gil Perzy, Holon (IL); Frieda-Gila Revel, Rehovot (IL); Galina Rubinshtein, Holon (IL); Uri Segev, Or-Yehuda (IL); Ofira Tal-Aviv, Moshav Bitzaron (IL); Dror Yaffe, Tel-Aviv (IL)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 11/748,056

(22) Filed: May 14, 2007

(51) Int. Cl. G06F 15/16

(52) U.S. Cl. 709/201

(57) ABSTRACT

A presence server architecture includes a central presence information database to store presence information about a multiplicity of publishing entities, and at least two presence servers to separately access and update said presence information. The present invention also includes a presence server which includes a means to access a central database storing presence information segments about each user from multiple publishing entities over time, an aggregator to aggregate said presence information segments about one user into a current presence information document, and means to detect if another presence server has recently modified presence information document about the user.

The present invention relates to presence server management in computer network environments generally and to using multiple presence servers in a scalable architecture in particular.

### BACKGROUND OF THE INVENTION

Presence servers are known in the art. Such servers receive and maintain presence information regarding entities, such as computer or cell phone users, and provide presence information about the entities to subscribers. Presence servers receive requests from publishing entities to publish presence information, as well as subscription requests from subscribing entities wishing to receive the published presence information. Such publication and notification requests are typically active for a predefined period of time in accordance with an expiration time that is specified for each request.

Publishing entities are logical sources of information, such as an individual. The individual may have a cell phone and a personal computer, both of which are capable of providing presence information regarding the same individual at the same time. The presence information from the cell phone may differ or even conflict with the presence information from the personal computer. Other sources of presence information include, for example, telephones, mobile devices, personal devices and laptop computers. A presence server must be capable of combining the presence information received from these disparate sources in order to create a single consistent view of the status of the publishing entity (i.e. the individual).

As long as a publish request is active, the published presence information is maintained by the presence server. When the publish request expires, the presence server deletes the related presence information. Similarly, as long as a subscription request is active, the presence server sends notifications regarding any updates to the requested presence information. When the subscribe request expires, the presence server stops sending presence information updates to the subscriber and notifies the subscriber that the subscription has expired.

In large presence management systems, with the potential for millions of publishing and subscribing entities, a multiple presence server architecture is typically used to share the load and maintain required levels of performance. FIG. 1, to which reference is now made, illustrates the manner in which the individual servers provide services to publishing and subscribing entities within the context of such an architecture.

Multiple presence server architecture 10 includes a multiplicity of presence servers 20. Each presence server 20 includes a large memory 25 in which the data for active presence sessions is stored, and provides publishing services to a multiplicity of publishing entities 30. Presence servers 20 also provide notification services to subscribing entities 35.

Each publishing entity 30 is assigned to a presence server 20 when it begins to publish publishing requests. For example, in architecture 10 publishing entity 30A is assigned to presence server 20A. Presence server 20A interprets the published information received from publishing entity 30A and stores it in memory 25A. Similarly, publishing entity 30B connects with presence server 20B, which in turn stores the interpreted information in memory 25B.

As long as the publishing session remains active, publishing entity 30A connects only with presence server 20A. It does not provide any presence information to any other presence server 20. It follows therefore, that memory 25A stores the only record of the current publishing session for publishing entity 30A.

Subscribing entities 35 connect with presence servers 20 in order to receive presence information relating to a specific publishing entity. For example, if subscribing entity 35A requests information regarding publishing entity 30A, it would connect to presence server 20A. Presence server 20A would then send subscriber entity 35A notifications with presence information regarding publishing entity 30A, as per the records stored in memory 25A.

Accordingly, whereas publishing entities 30 and presence servers 20 have a many to one relationship, subscribing entities 35 and presence servers 20 have a “many to many” relationship. For example, subscriber entity 35A may also request information regarding publishing entity 30B, whose presence information may be stored in in-memory 25B. In such a case, subscribing entity 35A must connect with both presence servers 20A and 20B in order to receive the subscribed information.

Each new publish request received has to be “diagnosed” to establish whether or not it belongs to a currently active presence session. It must then be forwarded to the relevant presence server 20. Similarly, subscribe requests must also be analyzed and forwarded to relevant presence servers 20. As described hereinabove, the connections required for subscription requests are determined by which presence server 20 is already handling the relevant active presence session. Over time this may lead to imbalances in load management and may impact on performance.

### SUMMARY OF THE PRESENT INVENTION

An object of the present invention is to improve upon the prior art.

There is therefore provided, in accordance with an embodiment of the present invention, a presence server including means to access a central database, an aggregator, and means to detect actions performed by another presence server. The central database stores presence information segments about each user from multiple publishing entities over time, and the aggregator aggregates the presence information segments about one user into a current presence information document. The actions detected are recent modifications of the user's presence information document.

Further in accordance with an embodiment of the present invention, each of the presence servers also includes means for updating at least one other presence server.

Still further in accordance with an embodiment of the present invention, the presence server also includes a request processor to process requests from any of the publishing entities irrespective of which of the presence servers processed previous requests of the publishing entities.

Additionally, in accordance with an embodiment of the present invention, the presence server also includes means to utilize SIP identification information as identifiers.

Moreover, in accordance with an embodiment of the present invention, the presence server also includes an expiration manager to set expiration timers for the expiration of the presence information segments and of subscription requests.

Further in accordance with an embodiment of the present invention, the request processor includes an aggregator to aggregate presence information from the requests and generate the presence information segments.

Still further in accordance with an embodiment of the present invention, the presence information segments include information provided by a multiplicity of publishing sources, each of each publishing sources being associated with one of the multiplicity of publishing entities.

Additionally, in accordance with an embodiment of the present invention, the presence server also includes means to distribute the presence information documents associated with specific publishing entities to their associated subscribing entities.

There is also provided, in accordance with an embodiment of the present invention, a method for managing multiple presence servers. The method includes receiving presence information from a multiplicity of publishing entities, storing the presence information on a central database; and aggregating the presence information on at least one presence server.

Further in accordance with an embodiment of the present invention, the method also includes updating the central database with the aggregated presence information.

Still further in accordance with an embodiment of the present invention, the stored presence information includes presence information segments.

Additionally, in accordance with an embodiment of the present invention, the updating includes detecting concurrent updating by another presence server.

Moreover, in accordance with an embodiment of the present invention, the method also includes utilizing SIP identification information as identifiers for the presence information segments.

Further in accordance with an embodiment of the present invention, the method also includes setting expiration timers for the expiration of the presence information segments and of subscription requests.

There is also provided, in accordance with an embodiment of the present invention, a computer product for managing multiple presence servers. The method includes receiving presence information from a multiplicity of publishing entities, storing the presence information on a central database; and aggregating the presence information on at least one presence server.

Further in accordance with an embodiment of the present invention, the computer product also includes updating the central database with the aggregated presence information.

Still further in accordance with an embodiment of the present invention, the stored presence information includes presence information segments.

Additionally, in accordance with an embodiment of the present invention, the updating includes detecting concurrent updating by another presence server.

Moreover, in accordance with an embodiment of the present invention, the computer product also includes utilizing SIP identification information as identifiers for the presence information segments.

Further in accordance with an embodiment of the present invention, the computer product also includes setting expiration timers for the expiration of the presence information segments and of subscription requests.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic drawing of a prior art presence server architecture;

FIG. 2 is a schematic illustration of a novel presence server architecture, constructed and operative in accordance with the present invention;

FIG. 3 is a schematic illustration of the process of presence information document generation included within the architecture of FIG. 2; and

FIGS. 4 and 5 are flow charts flow of control between the various entities included in the architecture of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

Applicants have realized that prior art presence servers do not scale well. Such servers may typically suffer from performance degradation whenever more than 100,000 presence sessions are active. Also, as richer information becomes available, overall performance may degrade even further.

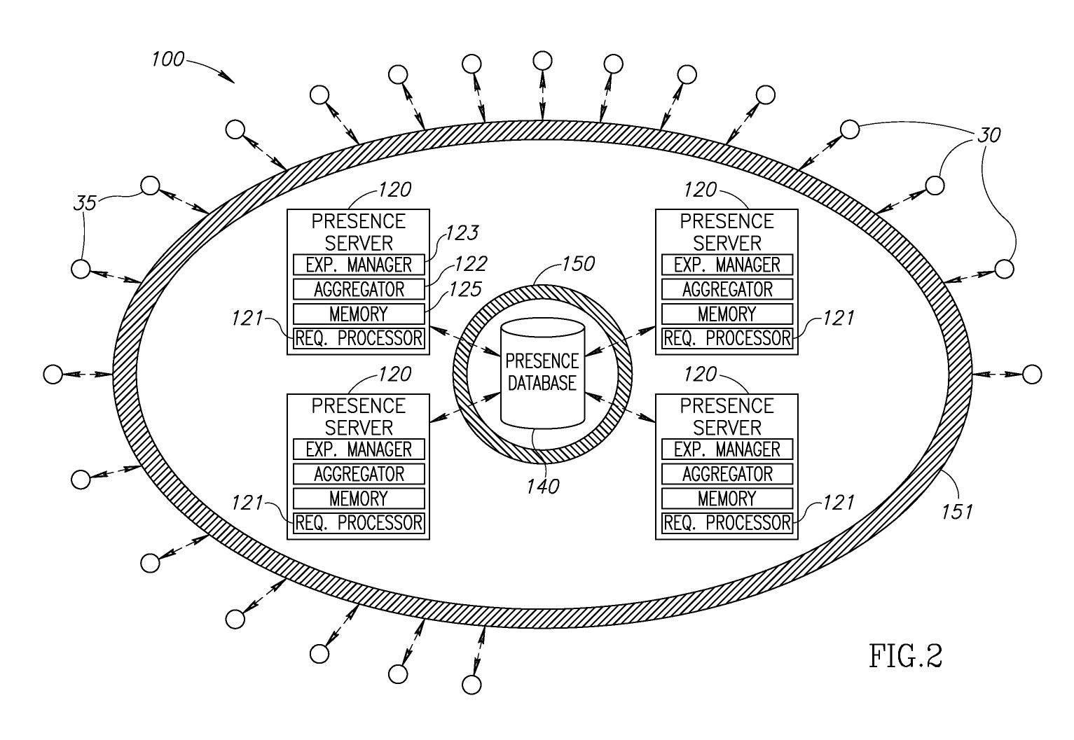

Applicants have also realized that using a central database to track ongoing presence sessions may result in a more scalable architecture which may more easily handle higher usage volumes and richer information. Reference is now made to FIG. 2 which illustrates a novel scalable presence server architecture 100, constructed and operative in accordance with the present invention.

In accordance with an embodiment of the present invention, architecture 100 may comprise a multiplicity of presence servers 120 sharing a single logical presence database 140. Presence servers 120 may communicate with each other via a presence brokerage layer 150, and may communicate directly with presence database 140.

Publishing requests from publishing entities 30 may be received by proxy service 151 and forwarded to any presence server 120 for service. Unlike the prior art, any presence server 120 may provide service to any publishing entity 30, regardless of whether or not a presence session has already been initiated on a different presence server 120. Architecture 100 may thus provide a “many to many” relationship between publishing entities 30 and presence servers 120.

In accordance with an embodiment of the present invention, publishing entities 30 and subscribing entities 35 may use SIP (Session Initiation Protocol) for communication. SIP may include identifiers for publishing entities 30 and subscribing entities 35 and their associated requests. Such identifiers may therefore be used throughout architecture 100 to uniquely identify individual entities 30 and 35 and/or their requests. The remaining explanation will be provided using the SIP protocol. It will be appreciated that the present invention may also be implemented in other protocols.

Publishing entities 30 may use one of two types of publishing requests support by SIP; either “publish” or “register”. Register requests may be simpler in nature and used for older devices, whereas publish requests may typically include richer detail. Unless otherwise noted, the processing of such requests may generally be considered to be the same. Subscribing entities 35 may use SIP “subscribe” requests.

Publishing and subscribing entities 30 and 35 may use one or more SIP clients (for example, on a personal computer and/or telephone) to create such requests that are forwarded to presence servers 120. These clients may also be used to interpret the notifications received from presence servers 120.

Presence servers 120 may comprise request processors 121 using SIP server software (not shown) to interpret SIP requests and compose SIP notifications. Each presence server 120 may also comprise an aggregator 122, an expiration manager 123 and a memory 125. Aggregators 122 may aggregate most or all of the available presence information for a given publishing entity 30 to produce a complete and updated presence report. Such reports are referred to as “documents” and the component pieces of information are known as “segments.” Expiration managers 123 may set and monitor expiration timers for the individual segments.

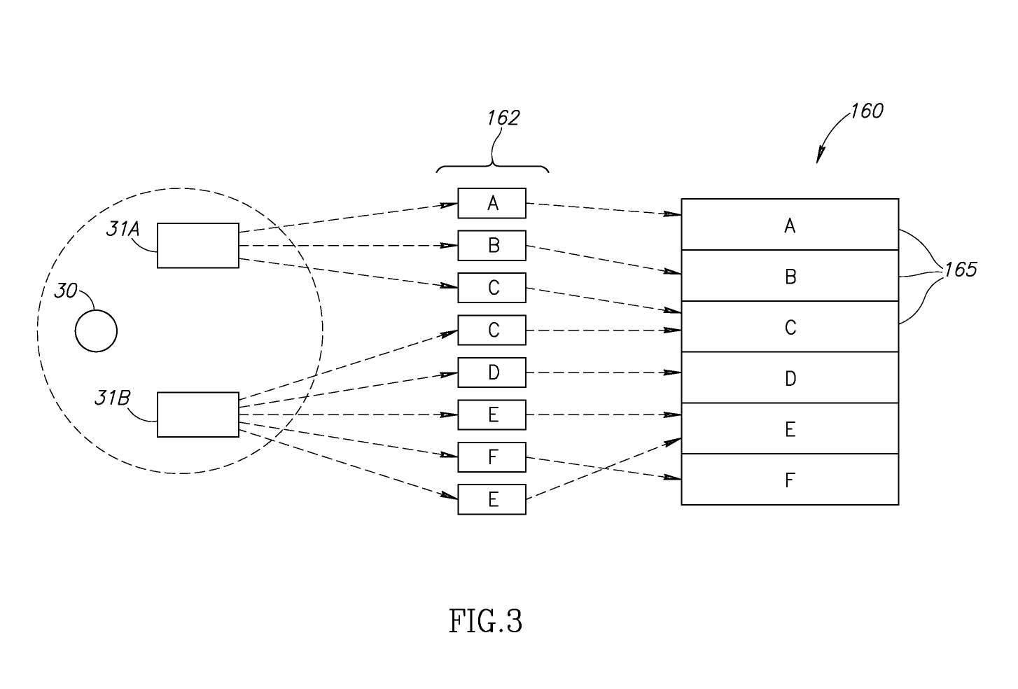

Reference is now also made to FIG. 3 which illustrates the relationship between a publishing entity 30 and its associated presence information document 160. Publishing entity 30 may have two SIP clients 31A and 31B associated with it, representing, for example, a cell phone and a personal computer registered as used by entity 30. SIP clients 31 may issue a number of publish requests 162.

Aggregators 122 (FIG. 2) may aggregate publish requests 162 into a single presence information document 160. Each type of publish request 162 may be formatted as a segment 165 in presence information document 160. Each publish request 162 may include an expiration tag defining how long it may still be valid for inclusion in presence information document 160. Expiration managers 123 (FIG. 2) may set expiration timers for the relevant segments in accordance with such expiration tags.

It will be appreciated that some or all of the requests 162 issued by SIP clients 31 may overlap. For example, SIP client 31A may issue requests 162 of types “A”, “B”, and “C”. SIP client 31B may issue requests 162 of type “C”, “D”, “E”, and “F”, such that both clients 31 have issued a potentially conflicting request of type “C”. Similarly, over time a single SIP client 33 may repeat a publish request 162 that it had previously issued. For example, SIP client 31B may issue two publish requests 162 of type “E”. Aggregators 122 may resolve such conflicts by updating existing segments 165 according to the most recent publish requests 162 received.

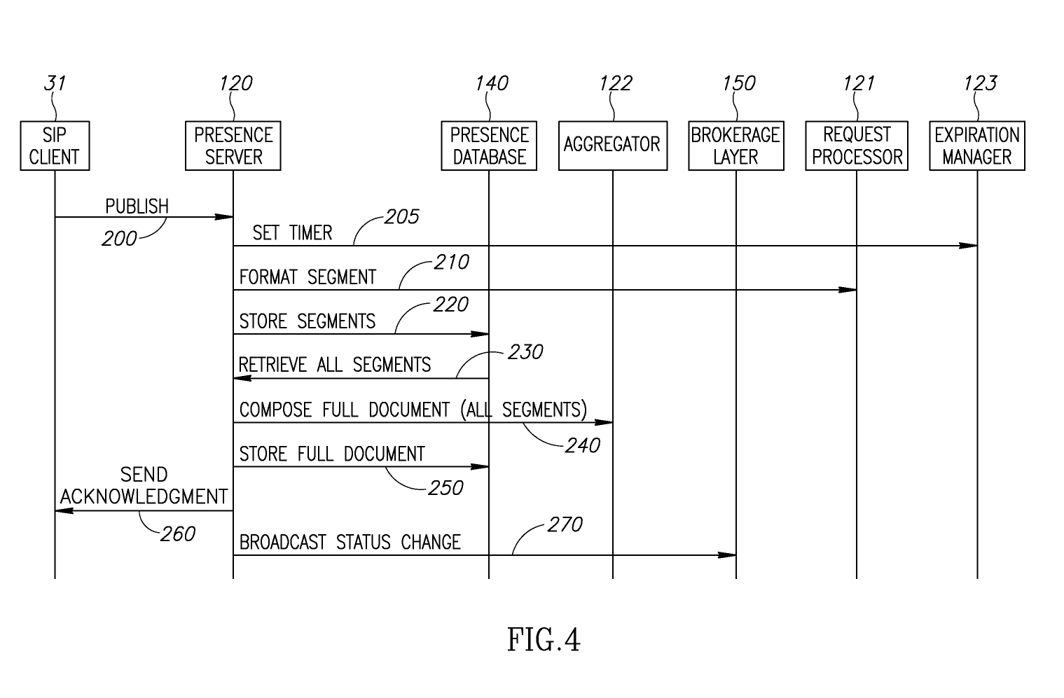

Reference is now also made to FIG. 4 which illustrates the flow for processing publishing requests 162 (FIG. 3). The top row shows the objects that may be involved in the various processes, and the succeeding rows show the process steps as per the order in which they may be performed. Similar reference numerals may refer to similar objects in FIGS. 2 and 3.

SIP client 31 may publish (arrow 200) presence information as a publish request 162. The request may be routed via proxy service 151 (FIG. 2) to any available presence server 120. Expiration manager 123 may then set (arrow 205) an expiration timer in accordance with the expiration tag on the forwarded request.

Request processor 121 may format (arrow 210) publish request 162 as a segment 165 and store (arrow 220) it in presence database 140. The next step may be to retrieve (arrow 230) from presence database 140 all of the current non-expired segments 165 that are associated with the relevant publishing entity 30.

Aggregator 122 may compose (arrow 240) a complete and updated presence information document 160 based on the segments 165 retrieved from presence database 140. Document 160 may then be stored (arrow 250) in presence database 140.

After the document may be successfully stored, presence server 120 may send (arrow 260) an acknowledgement notification to SIP client 31. The final step in the process may be to broadcast (arrow 270) the status change to other presence servers 120 via presence brokerage layer 150. As described herein below, presence servers 120 may then notify relevant subscribing entities 35 regarding the change in status.

It will be appreciated that when the timer that was set in step 205 expires, the published information may no longer be valid. It will further be appreciated, that a publication may be renewed by issuing a new publish request prior to the expiration of the previous one.

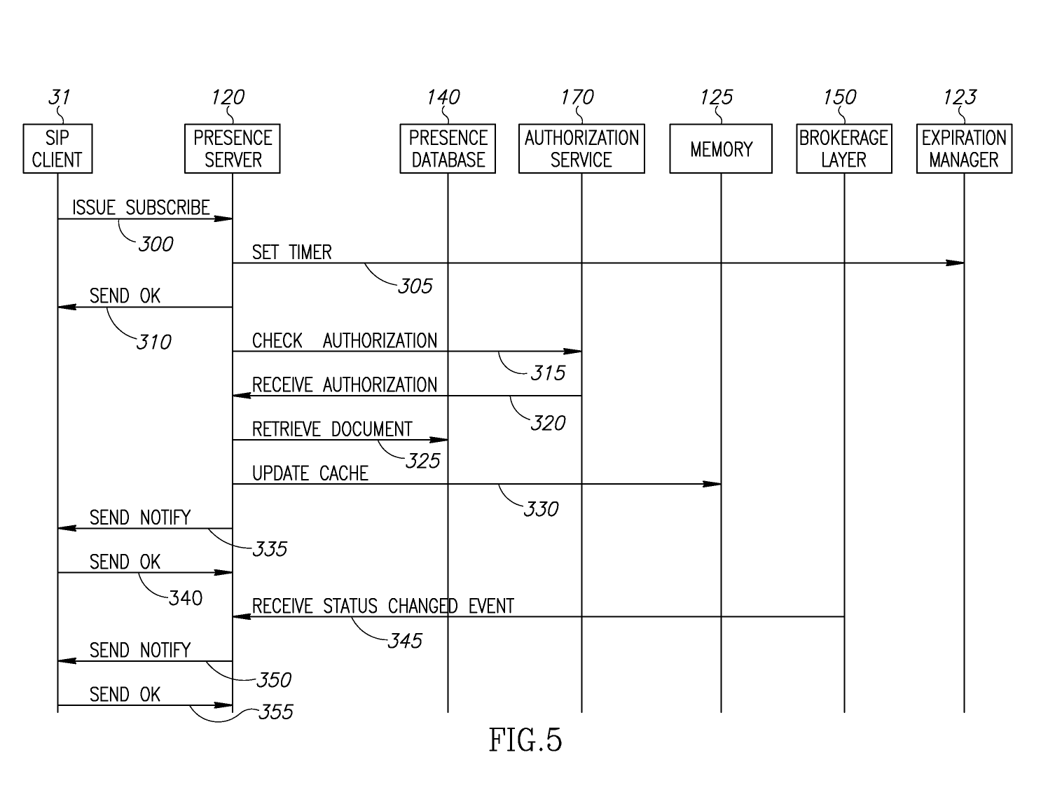

Reference is now made to FIG. 5 which illustrates the flow for processing subscription requests. The top row shows the objects that may be involved in the various processes, and the succeeding rows show the process steps as per the order in which they may be performed. Similar reference numerals may refer to similar objects in FIGS. 2 and 3. SIP client 36 may represent an object associated with a subscribing entity 35 (FIG. 2).

SIP client 36 may issue (arrow 300) a subscribe request for presence information regarding a particular publishing entity 30. The request may be routed via proxy service 151 FIG. 2) to any available presence server 120. The expiration manager 123 associated with the responding presence server 120 may then set (arrow 305) an expiration timer in accordance with the expiration tag on the forwarded request. Presence server 120 may also then send (arrow 310) an OK acknowledgement to SIP client 36.

Presence information document 160 associated with the relevant publishing entity 30 may then be retrieved (arrow 325) from presence information database 140. Presence server 120 may then update (arrow 330) memory 125 with document 160.

Presence server 120 may also send (arrow 335) presence information document 160 to SIP client 36. SIP client 36 may send (arrow 340) an OK to acknowledge receipt.

As described hereinabove in step 270, changes in document status may be broadcast to all presence servers 120 via presence brokerage layer 150. When a status changed event may be received (arrow 345) via presence brokerage layer 150, presence server 120 may repeat steps 325 and 330 in order to receive and store an updated version of the relevant document 160. It may then send (arrow 350) the updated document 160 to SIP client 36. SIP client 36 may then send (arrow 355) an OK to acknowledge receipt.

It will be appreciated that when the timer that was set in step 305 expires, presence server 120 may stop sending presence information to SIP client 36 until a new subscribe request may be received. It will further be appreciated, that a subscription may be renewed by issuing a new subscribe request prior to the expiration of the previous one.

In accordance with an embodiment of the present invention, subscribing entities 35 and presence servers 120 may have a “many to one” Although a subscribing entity 35 may initiate a subscription session with any presence server 120, once a session has been initiated with a specific presence server 120, it may maintain an ongoing dialogue with the relevant presence server 120 until the end of the subscription session. It will be appreciated that presence servers 120 may maintain multiple such sessions simultaneously.

Presence server 120 may periodically perform housekeeping tasks on presence information documents 160. In an exemplary embodiment of the present invention, such a period may be defined as once every 60 seconds. Presence information documents 160 may be retrieved from database 140 and their associated timers checked by expiration manager 123. Segments 165 whose timers may have expired may be deleted from documents 160 before being stored again database 140

It will be appreciated that by such deleting of out-of-date segments 165 documents 160 may more accurately represent the up-to-date status of a given publishing entity 30. Such periodic “pruning” of documents 160 may also reduce demands for memory on presence servers 120 and may conserve disk space used by presence information database 140. It will further be appreciated that the overall effect may be improved performance.

It will be appreciated that architecture 100 as described hereinabove may be scalable and may accordingly be scalable to an unlimited number of associated presence servers.

It will be appreciated that presence information database 140 may be a virtual unit comprising a multiplicity of physical and logical components.

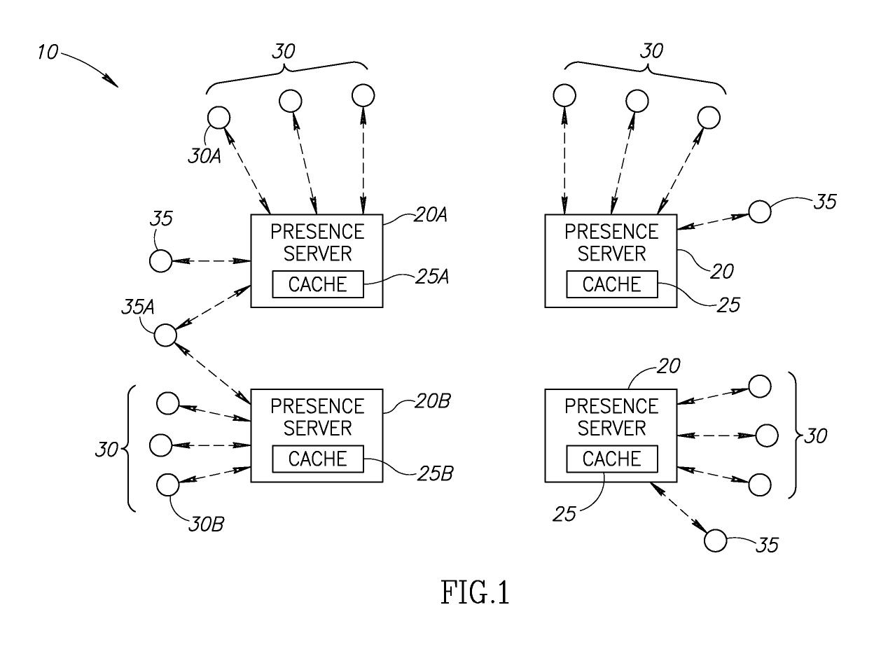

In an exemplary embodiment of the present invention, architecture 100 (FIG. 1) may be implemented using standard J2EE components available from Sun Microsystems, Inc. of the United States. Presence servers 120 may be deployed on J2EE application servers; JMS (Java Messaging System) may be used to implement the presence brokerage layer; and JDBC (Java Database Connectivity) may be used to communicate with presence database 140. Presence database 140 may be implemented on a standard database system, for example, Oracle 10 from Oracle Corporation of the United States.

It will be appreciated that other standard technologies may be used in addition to, or in place of J2EE to implement architecture 100 as described hereinabove. It will similarly be appreciated other session protocols may be used in addition to, or in place of SIP to implement architecture 100 as described hereinabove.

In the above detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the above discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented hereinabove are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description above. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A presence server comprising:
means to access a central database storing presence information segments about each user from multiple publishing entities over time;
an aggregator to aggregate said presence information segments about one user into a current presence information document; and
means to detect if another presence server has recently modified said presence information document about said user.

2. The presence server according to claim 1 and wherein each said presence server comprises means for updating at least one other presence server.

3. The presence server according to claim 2 and comprising a request processor to process requests from any of said publishing entities irrespective of which of said presence servers processed previous requests of said publishing entities.

4. The presence server according to claim 1 and comprising means to utilize SIP identification information as identifiers.

5. The presence server according to claim 1 and also comprising an expiration manager to set expiration timers for the expiration of said presence information segments and of subscription requests.

6. The presence server according to claim 3 and wherein said request processor comprises an aggregator to aggregate presence information from said requests and generate said presence information segments.

7. The presence server according to claim 6 and wherein said presence information segments comprise information provided by a multiplicity of publishing sources, each of said publishing sources being associated with one of said multiplicity of publishing entities.

8. The presence server according to claim 1 and also comprising means to distribute said presence information documents associated with specific publishing entities to their associated subscribing entities.

9. A method for managing multiple presence servers, the method comprising:
receiving presence information from a multiplicity of publishing entities;
storing said presence information on a central database; and
aggregating said presence information on at least one presence server.

10. The method according to claim 9 and also comprising updating said central database with said aggregated presence information.

11. The method according to claim 9 and wherein said stored presence information comprises presence information segments.

12. The method according to claim 9 and wherein said updating comprises detecting concurrent updating by another said presence server.

13. The method according to claim 11 and comprising utilizing SIP identification information as identifiers for said presence information segments.

14. The method according to claim 11 and also comprising setting expiration timers for the expiration of said presence information segments and of subscription requests.

15. A computer product readable by a machine, tangibly embodying a program of instructions executable by the machine to perform method steps for managing multiple presence servers, said method steps comprising:
receiving presence information from a multiplicity of publishing entities;
storing said presence information on a central database; and
aggregating said presence information on at least one presence server.

16. The computer product according to claim 15 and also comprising updating said central database with said aggregated presence information.

17. The computer product according to claim 15 and wherein said stored presence information comprises presence information segments.

18. The computer product according to claim 15 and wherein said updating comprises detecting concurrent updating by another said presence server.

19. The computer product according to claim 17 and comprising utilizing SIP identification information as identifiers for said presence information segments.

20. The computer product according to claim 17 and also comprising setting expiration timers for the expiration of said presence information segments and of subscription requests.
